(19) United States
(12) Patent Application Publication
(10) Pub. No.: US 2011/0179859 A1
(43) Pub. Date: Jul. 28, 2011

(54) CHARACTERIZATION METHOD AND KIT FOR CARRYING OUT THE METHOD

(75) Inventors: Ian Hemmings, Derbyshire (GB); Osmo Suovaniemi, Helsinki (FI)

(73) Assignee: Biohit Oyi, Helsinki (FI)

(21) Appl. No.: 13/054,479

(22) PCT Filed: Jul. 2, 2009
(86) PCT No.: PCT/FI09/50606

§ 371 Date: Apr. 8, 2011

(30) Foreign Application Priority Data
Jul. 16, 2008 (FI) 20085729

(51) Int. Cl. G01F 17/00

(52) U.S. Cl. 73/149

(57) ABSTRACT

The present invention relates to evaluating the performance of an automated matrix-format liquid handling system by using receptacles and caps. The invention provides a method comprising the steps of determining a receptacle weight for each receptacle, determining a mean cap weight for the caps, dispensing a volume of liquid in each receptacle by using the liquid handling system, capping each receptacle approximately simultaneously with respect to each other, determining a gross weight for each capped receptacle, and calculating the volume of liquid dispensed in each receptacle from the respective gross weight, the respective receptacle weight, and the mean cap weight. The invention further provides a kit for carrying out the method, the kit comprising a plurality of receptacles, a plurality of caps, a holder device for arranging the receptacles in accordance with liquid dispensing positions in the liquid handling system, and a capping device for capping the receptacles.

### FIELD OF THE INVENTION

The present invention relates to evaluating the performance of an automated liquid handling system.

### BACKGROUND OF THE INVENTION

Automated liquid handling systems, or liquid handling robots, are in common use nowadays in laboratories, especially within clinical laboratories and within the pharmaceutical industry. Liquid handling systems use a movable dispensing head for dispensing liquid in receptacles, e.g. wells of a microplate, resting on a dispensing platform of the system. A dispensing head comprises one or more dispensing channels in a row or matrix arrangement typically matching the dimensions of a microplate. Common dispensing heads include 1, 8, 12 and 96-way dispensing heads. Depending on the type of dispensing head used, the receptacles may be filled by the liquid handling system either one by one, row by row, or all at the same time.

A common way of evaluating the performance of a liquid handling system is to place a balance on the robotic platform, or the dispensing platform, to place a receptacle on the balance and to get the robot to dispense in the receptacle. The volume dispensed is determined from the weight gain of the receptacle. This has several drawbacks; the balance is not going to be stable and not traceable since the balance is not usually calibrated after installation into the robot.

A way to circumvent the above-mentioned problems is to resort to photometric techniques in determining the volume of liquid dispensed. The publication US 2006/0063272 A1, entitled “Method for characterizing a highly parallelized liquid handling technique using microplates and test kit for carrying out the method”, discloses a combined gravimetric and photometric method for characterizing a liquid handling system. According to the method, a mean dispensed liquid volume is first determined gravimetrically for a microplate, then a normalized mean optical intensity is formed from optical intensities of all liquid volumes mixed with a diluent, and finally the accuracy of every individual channel of the liquid handling system with respect to the mean liquid volume is determined from the deviation of the normalized optical intensity of the individual channel in relation to the normalized mean optical intensity.

According to US 2006/0063272 A1, determining the absorbance values for the wells of a microplate is accomplished with a commercial microplate reader. However, such microplate readers are very expensive and consequently not available in all laboratories where a characterization of a liquid handling system is required. The method further necessitates the use of special indicators, or dyes, which adds to the costs and limits the range of liquids that may be dispensed, since the dye must dissolve completely in the liquid to be dispensed. The method also requires the use of microplates. Further, photometric techniques are susceptible to errors caused by bubbles, pH changes and path length variations due to meniscus formation.

Consequently, there is a current need for a simple and reliable characterization method for automated liquid handling systems.

### SUMMARY OF THE INVENTION

The present invention relates to evaluating the performance of an automated matrix-format liquid handling system. The method according to the present invention uses standard gravimetric techniques for determining the volume of liquid dispensed. The present invention enables liquid to be collected in a matrix format or an array format, for example in a microplate format, such as the 96-well format or the 386-well format, and the performance of each liquid dispensing position to be evaluated individually by simple and reliable gravimetric techniques. Further, the present invention enables the use of a calibrated balance. A true map of the liquid handling system's performance in terms of standard deviation, accuracy and precision can be obtained. As the method according to the present invention uses standard gravimetric techniques for determining the volume of liquid dispensed, the method may be implemented in the form of an accredited service or product (e.g. according to the standards ISO17025, UKAS and/or FINAS). The method according to the present invention can be performed remotely, i.e. an end user carries out the actual dispensing steps by the liquid handling system to be characterized and then delivers the filled and capped receptacles to a calibration service provider for processing and analysis.

The present invention provides a method for evaluating the performance of a matrix-format liquid handling system by using a plurality of receptacles and a plurality of caps, the method comprising the steps of determining a receptacle weight for each receptacle; determining a mean cap weight for the caps; dispensing a volume of liquid in each receptacle by using the liquid handling system; capping each receptacle approximately simultaneously with respect to each other; determining a gross weight for each capped receptacle containing said volume of liquid; and calculating the volume of liquid dispensed in each receptacle from the respective gross weight, the respective receptacle weight, and the mean cap weight.

The present invention further provides a kit for carrying out the method, the kit comprising a plurality of receptacles; a plurality of caps; a holder device for arranging the receptacles in accordance with liquid dispensing positions in the liquid handling system; and a capping device for capping the receptacles approximately simultaneously with respect to each other.

### DETAILED DESCRIPTION OF A PREFERRED EMBODIMENT OF THE INVENTION

In the following, a preferred embodiment of the present invention is described in detail.

According to a preferred embodiment, bespoke software is used in carrying out the method according to the present invention. The use of bespoke software facilitates and streamlines the process. The software can be used for example for processing and storing data accumulated in the method, e.g. weight and identification data, typically for the receptacles, for calculating results, and for producing reports and certificates. However, other means may be used for these purposes as well.

The method of the present invention uses a plurality of receptacles and a plurality of caps for determining a volume of liquid dispensed by an automated liquid handling system. Suitable receptacles for use in the method according to the present invention are e.g. glass vials. The number of receptacles needed for carrying out the method depends on the number of liquid dispensing positions to be characterized. One receptacle is needed for each liquid dispensing position to be characterized. For example, to characterize a 96-position liquid handling system (with any type of dispensing head), 96 receptacles are sufficient. The receptacles are preferably labelled in order to append unique identification information to each of them. Most preferably, the receptacles are labelled with a bar code or any other code that can be machine-read for example with the help of a bar code reader or like. The identification information may include a serial number. Bar code labelling may be accomplished by using a permanent printing process or by attachment of sticky labels.

Prior to evaluation, the receptacles are preferably first dried in a drying oven to ensure no residual moisture. Then, a receptacle weight is determined for each receptacle individually with a calibrated balance. Preferably, the receptacle weights together with the respective identification information are entered into the software. The steps of drying and weighing the receptacles need to be done when carrying out the method for the first time. Usually the receptacle weights need to be revalidated periodically thereafter (for example every 6 months), or every time new receptacles or a new balance are introduced.

After determining the receptacle weights, the receptacles are placed in a holder device, which provides an arrangement of receptacles matching the arrangement of the liquid dispensing positions. According to a preferred embodiment, the holder device is a machined block of plastic which has the dimensions of a standard deep-well microplate, i.e. 127.8 mm width, 85.5 mm length, and 42.2 mm height, and into which holes for receiving the receptacles have been formed so that they match the matrix of a microplate. According to a preferred embodiment, the holes have been formed in such a way as to enable 96 1-ml receptacles to be loaded into the block as an 8×12 matrix. However, it is possible to apply the method according to the present invention also in other microplate formats, e.g. in 6, 24 or 384-well formats, by using blocks with appropriate dimensions and a respective number and arrangement of holes.

According to the invention, the liquid dispensing positions in the liquid dispensing system are arranged as an array or a matrix, for example a rectangular matrix or a square matrix or any other suitable regular array. Preferably, the liquid dispensing positions are arranged as a microplate-format matrix.

According to a preferred embodiment, the holder device has been labelled in order to append unique identification information to it. Most preferably, the holder device has been labelled with a bar code or any other code that can be machine-read for example with the help of a bar code reader or like. The identification information may include a serial number. Bar code labelling may be accomplished by using a permanent printing process or by attachment of sticky labels.

According to a preferred embodiment, the software can instruct the user which position within the matrix of the block to place each of the receptacles, and it remembers this position. Alternatively, the user may deduce the correct position from the identification information provided on the receptacle.

Preferably, the loaded holder device is covered with a bespoke lid to prevent contamination of the receptacles. The lid is removed as dispensing is started.

The loaded holder device is transferred onto a dispensing platform of the liquid handling system. A volume of liquid, preferably water, is dispensed in each receptacle. It should be noted that the method according to the present invention is applicable to any liquid with which the liquid handling system to be characterized is compatible. The dispensed volume may be the same for all receptacles, or any desired combination of volumes may be selected by the user. The receptacles in the holder device can be filled for example with a single, an 8-way or a 12-way dispensing head. According to a preferred embodiment, the method is applicable for volumes ranging from about 0.1 μl to about 1 ml.

Each receptacle is capped with a cap to reduce evaporation of the liquid dispensed. Preferably, individual soft seal caps are used. The caps to be used for capping are first weighed individually and a mean cap weight is calculated for the caps. Preferably, the cap weights are entered to the software, which calculates the mean cap weight. The standard deviation of the cap weight can be calculated and applied as part of the uncertainty of measurement.

The receptacles are capped with the help of a capping device that enables the user to cap all the receptacles quickly and approximately simultaneously. According to a preferred embodiment, the capping device is a microplate-format mechanical device into which the caps can be preloaded for capping. The capping device comprises a positioning means that enables the capping device to be easily positioned over the top of the holder device. A locking means on both sides of the capping device locks the entire capping device to the holder device, sealing each receptacle approximately simultaneously. The capping device can be removed so that the caps stay firmly in place in the receptacles. The use of the capping device reduces the time that the receptacles remain uncapped after dispensing.

The filled and capped receptacles may be analyzed on-site by the end user or they may be transported to a calibration service provider who carries out the analysis.

According to a preferred embodiment, in the beginning of the analysis, the bar code of the holder device is read with a bar code reader and entered to the software, which identifies which holder device is to be processed and, based on the entered code, instructs the user which receptacle to weigh and brings up a matrix on a display for entering weight data.

A gross weight is determined for each capped receptacle containing the volume of liquid dispensed. The gross weight is the combined weight of the receptacle, the cap and the liquid. According to a preferred embodiment, the holder device is placed on a lifting device, which raises a set of receptacles to be weighed. This makes it easier to lift the receptacles out of the holder device. According to a preferred embodiment, as the software instructs the user to select a particular receptacle, the user lifts that receptacle out of the holder device, reads the respective receptacle bar code using a bar code reader to identify the receptacle, and places the receptacle onto a tared balance that has been calibrated. The software records a gross weight, subtracts the mean cap weight and the respective receptacle weight to obtain a net weight. From the net weight, the software calculates the volume of liquid dispensed. The calculation of liquid volume based on liquid weight is a procedure well known to a person skilled in the art. Preferably, the user measures and enters air temperature and air pressure values to enable the software to apply a correction when calculating the volume of liquid dispensed.

The user places the processed receptacle back into its original location, moves onto the next receptacle, and repeats the same procedure until all the receptacles have been analyzed.

Once all the receptacles have been weighed, the user can select which receptacles the user wishes to analyze. The software allows the user to select a row, a column, the entire matrix or any desired subset thereof and to perform mean, accuracy and precision calculations on the selected set and to produce a report based upon the selected criteria.

A mean evaporation rate can be determined separately for liquid dispensed in receptacles that are left uncapped. The mean evaporation rate is applied as part of the measurement uncertainty. When conducting the actual analysis, the end user needs to record the time from start of filling to capping and the number of receptacles filled. This information, in addition to the mean evaporation rate, is used in calculating the uncertainty associated with evaporation.

The processed receptacles can be uncapped, emptied, dried in a drying oven and used again. The caps can be dried in a drying oven and used again as well.

A kit according to the present invention comprises a plurality of receptacles, a plurality of caps, a holder device for arranging the receptacles in accordance with liquid dispensing positions in the liquid handling system, and a capping device for capping the receptacles approximately simultaneously with respect to each other. Preferably, the kit further includes a thermometer, a manometer, a lifting device for raising a set of receptacles out of the holder device, and a matrix form for entering what volumes have been dispensed in which receptacles.

A calibration service provider can provide a kit to an end user, who then fills the kit by the liquid handling system to be characterized, and returns the filled kit to the calibration service provider for analysis and production of certificate. Alternatively, a service engineer can be sent out with a kit, and preferably with software and a balance, from a calibration service provider to an end user, whereby the service engineer performs the characterization of the liquid dispensing system on-site together with the end user.

The embodiments described above are to be construed as exemplary only and not to limit the scope of the present invention. The method and the kit according to the present invention may be used for characterizing automated liquid handling systems with any number and arrangement of liquid dispensing positions. The method may include the use of software but it is not necessary for carrying out the method. The method steps can be performed for example manually, or as individual steps by using commercial software products, or as a streamlined process by using bespoke software.

1. Method for evaluating the performance of a matrix-format liquid handling system by using a plurality of receptacles and a plurality of caps, the method comprising the steps of:
determining a receptacle weight for each receptacle;
determining a mean cap weight for the caps;
dispensing a volume of liquid in each receptacle by using the liquid handling system;
capping each receptacle approximately simultaneously with respect to each other;
determining a gross weight for each capped receptacle containing said volume of liquid; and
calculating the volume of liquid dispensed in each receptacle from the respective gross weight, the respective receptacle weight, and the mean cap weight.

2. Method according to claim 1, wherein said matrix-format liquid handling system is a microplate-format liquid handling system.

3. Method according to claim 1, wherein said liquid is water.

4. Method according to claim 1, which method includes the use of software.

5. Method according to claim 1, wherein the steps following the step of capping each receptacle are performed remotely by a service provider.

6. Method according to one of claims 1-5, wherein the steps preceding the step of dispensing a volume of liquid are performed remotely by a service provider.

7. Method according to any of claims 1-4, wherein the method further comprises:
determining air temperature and air pressure; and
correcting the calculated volume of liquid by taking into account said air temperature and said air pressure.

8. Kit for carrying out the method according to claim 1, the kit comprising:
a plurality of receptacles;
a plurality of caps;
a holder device for arranging the receptacles in accordance with liquid dispensing positions in the liquid handling system; and
a capping device for capping the receptacles approximately simultaneously with respect to each other.

9. Kit according to claim 8, wherein the holder device is a block of plastic, which has the approximate overall dimensions of a microplate and comprises holes that match a matrix of a microplate.

10. Kit according to claim 8 or claim 9, wherein the capping device is a microplate-format mechanical device into which the caps can be preloaded, which capping device comprises:
a positioning means for positioning the capping device over the top of the holder device; and
a locking means on both sides of the capping device for locking the capping device to the holder device.

11. Kit according to claim 8, wherein the receptacles have been labelled with a bar code to append identification information to each of them.

12. Kit according to claim 8, wherein the holder device has been labelled with a bar code to append identification information to it.

13. Kit according to claim 8, further comprising a lifting device for raising a set of receptacles out of the holder device.
